(19) United States
(12) Patent Application Publication
(10) Pub. No.: US 2009/0051670 A1
(43) Pub. Date: Feb. 26, 2009

(54) LIQUID CRYSTAL DISPLAY INCORPORATING TOUCH PAD

(75) Inventors: Xianfang WANG, Shenzhen (CN); Jianwei LIU, Shenzhen (CN)

Correspondence Address: PEARNE & GORDON LLP, 1801 EAST 9TH STREET, SUITE 1200, CLEVELAND, OH, 44114-3108, US

(73) Assignee: SHENZHEN H&T ELECTRONIC TECHNOLOGY CO., LTD., Shenzhen (CN)

(21) Appl. No.: 11/942,145

(22) Filed: Nov. 19, 2007

(30) Foreign Application Priority Data
Aug. 20, 2007 (CN) 200710076439.2

(51) Int. Cl. G06F 3/045

(52) U.S. Cl. 345/174

(57) ABSTRACT

A liquid crystal display incorporating touch pad, includes a liquid crystal module, a touch device, and a controller (80). The touch device includes a plurality of touch pads (72). The liquid crystal module includes a lower substrate (20), an upper substrate (10) and sealant (30). A gap is defined between the lower substrate and the upper substrate, and filled with liquid crystal. The sealant seals the gap. The plural touch pads are disposed on the outer surface of the upper substrate, and each touch pad is connected with an electrode (71). The electrodes are connected with a printed circuit board (76). The controller controlling graphic information display of the liquid crystal module is connected with the printed circuit board. Wherein the printed circuit board distinguishes each touch pad by recognizing current change created by a user, and pass the touch pad identification information to the controller for following process.

### BACKGROUND OF THE INVENTION

1. Field of the Invention

The present invention generally relates to an operable liquid crystal display, more particularly the present invention relates to an ultra thin liquid crystal display with optimized deployment structure and simplified fabrication process.

2. Background of the Invention

As known to those who skilled in the art, a liquid crystal display with a conventional touch panel include a liquid crystal module and a touch screen 10. The typical touch screen such as a resistive touch screen is an independent module, and adhered with the liquid crystal display in the front by resin gules. With the aforementioned structure, the liquid crystal display with touch screen is made thick and causes inconvenient issues for users.

In details, with reference to FIG. 1, the conventional liquid crystal display includes a lower substrate 4, an upper substrate 4, a lower indium tin oxide (ITO) film 6 and an upper ITO 5. An insulating film 7 and an alignment film 8 are sequentially formed on the respective opposite sides of the lower and upper substrate 4, 3. Liquid crystal (not labeled) is injected into a gap formed between the upper substrate 3 and the lower substrate 4, and a sealant 9 seals the gap therebetween so as to form a liquid crystal box. An upper polarizing plate 1 adhered to the upper surface of the upper substrate 3; and a lower polarizing plate 2 adhered to the lower surface of the lower substrate 4. The upper ITO film 5 on the upper substrate 3 is etched to form an address electrode array, and the lower ITO film 6 on the lower substrate 4 is etched to form a display electrode array, thereby defining a display matrix in a display area of the upper substrate 3 for displaying graphic information.

A typical touch screen is in various category, for example, resistive touch screen, infrared touch screen, capacitive touch screen, surface acoustic wave touch screen, and so on. With the development of semiconductor tech, the capacitive touch screen is getting to be the most popular one in recent application.

Another conventional means of making liquid crystal display with touch screen is disclosed. In general, the liquid crystal display response to signals from touch panel by a joining device, including printed circuit board layout, elastic member, conductive sponge, and etc., to guide the signal from the touch screen to a controller recognizing location of a contact point created by the user. However, the conventional configurations of the liquid crystal display with touch screen results in a thick and heavy apparatus which lack portable characteristic and lower mobility.

Accordingly, an operable liquid crystal display having specific configuration that overcomes the above-mentioned problems is desired.

### SUMMARY OF THE INVENTION

One object of the present invention is to develop an ultra thin liquid crystal display with optimized deployment structure and simplified fabrication process.

Further objects and features of the invention will be readily apparent to those skilled in the art from the following specification that includes the appended claims and drawings.

Briefly stated, to achieve the above objects in accordance with the purpose of the invention, in a preferred embodiment, a liquid crystal display incorporating touch pad, comprises a liquid crystal module, a touch device, and a controller. The touch device comprises a plurality of touch pads. The liquid crystal module comprises a lower substrate, an upper substrate and sealant. A gap is defined between the lower substrate and the upper substrate, and filled with liquid crystal. The sealant seals the gap. The plurality of touch pad are disposed on the outer surface of the upper substrate, each touch pad is connected with an electrode. Each of the electrodes is connected with a printed circuit board through an interface. The controller controlling graphic information display of the liquid crystal module is connected with the printed circuit board. The printed circuit board distinguishes each touch pad by recognizing current change created by a user, and pass the touch pad identification information to the controller for following process.

According to the present invention, the liquid crystal module combines with the plurality of touch pads of capacitive type right on the outer surface of the upper substrate, so that a display electrode array inside the liquid crystal module and the plurality of touch pads are integrated on respective two surfaces of the upper substrate, thereby simplifying the configurations of the touch device, and minimizing thickness of the whole display assembly.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is a sectional view of a conventional liquid crystal display;

FIG. 2 is an sectional view of the liquid crystal display incorporating touch pad of the present invention, comprising an upper substrate, a lower substrate, a touch pad module combining upon the upper substrate, and a plurality of indicating icons deployed on the touch pad module;

FIG. 3 is a plan view of the upper substrate in FIG. 2;

FIG. 4 is a plan view of the lower substrate in FIG. 2;

FIG. 5 is a schematic view of one embodiment of the touch pad module in FIG. 2;

FIG. 6 is a schematic view of another embodiment of the touch pad module in FIG. 2, but viewed from another aspect; and

FIG. 7 is a schematic view of the indicating icons in FIG. 2.

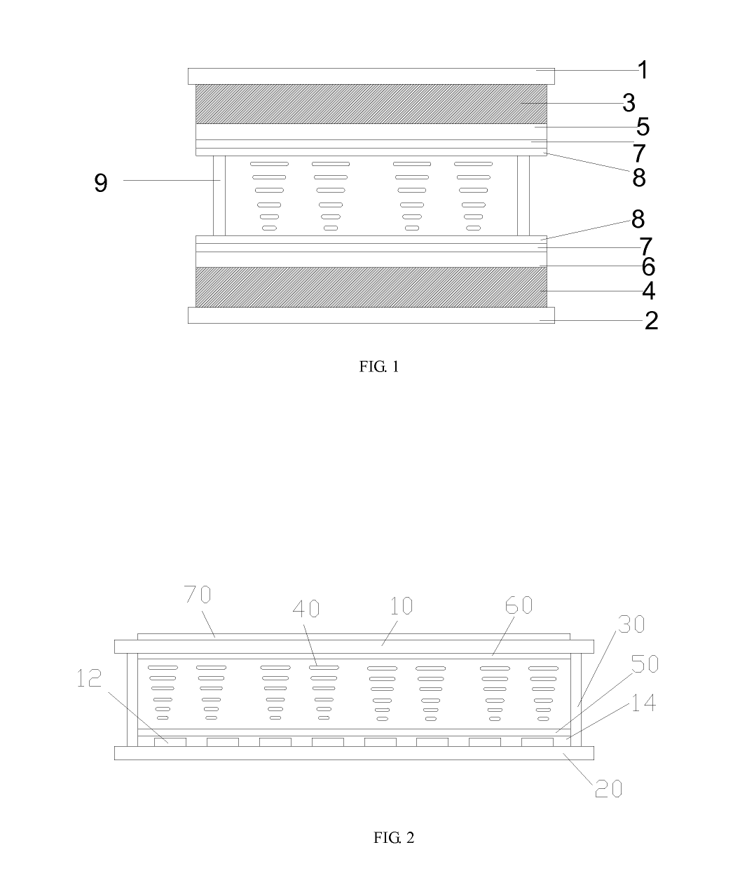

### DETAILED DESCRIPTION OF THE INVENTION

Throughout the drawings, the same reference numerals and characters, unless otherwise stated, are used to denote like features, elements, components or portions of the illustrated embodiments. Moreover, while the subject invention will now be described in detail with reference to the drawings, it is done so in connection with the illustrative embodiment. It is intended that changes and modifications can be made to the described embodiment without departing from the true scope and spirit of the subject invention as defined by the appended claims.

With reference from FIG. 2 to FIG. 7, a liquid crystal display incorporating touch pad in accordance with a preferred embodiment of the present invention includes a liquid crystal module, a touch device, a printed circuit board 76, and a controller 80.

The liquid crystal module. The liquid crystal module comprises a transparent lower substrate 20, a transparent upper substrate 10 and sealant 30. In the preferred embodiment of the present invention, the touch device is a transparent ITO (indium tin oxide) layer, etched right on the outer surface of the upper substrate 10. A gap is defined between the lower substrate 20 and the upper substrate 10, and inside the gap, liquid crystal 40 is filled. The sealant 30 seals the gap.

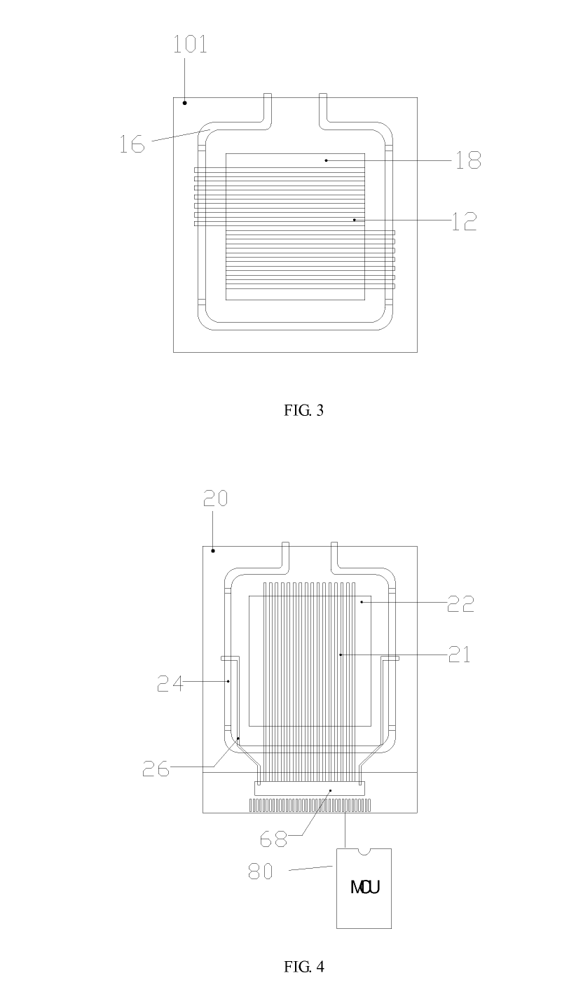

With reference to FIG. 3, an ITO layer 60 is adhered to the inner surface of the transparent upper substrate 10, and the ITO layer 60 defines a display window 18 on an inner surface 101 thereof. An address electrode array 12 is paralleled arranged in transversal direction across the display window 18. An ITO wiring 16 is disposed around the display window 18.

With reference to FIG. 4, an ITO layer 50 is adhered to the inner surface of the transparent lower substrate 20, and the ITO layer 50 defines a display window 22 on an inner surface thereof. A display electrode array 21 is paralleled arranged in vertical direction across the display window 22. The display electrode array 21 is in connection with the controller 80 aparting from the display window 22. An ITO wiring 24 is disposed around the display window 22 of the lower substrate 20. A connecting wiring 26 is jointed with the ITO wiring 24. The ITO wiring 24 is engaged with a connector 68. The ITO wiring 16 around the display window 18 on the upper substrate 10 is engaged with connector 68 by the connecting wiring 26. The connector 68 is directly engaged with the controller 80. The controller 80 controls graphic information display of the liquid crystal module. The ITO layer 50 on the inner surface of the transparent lower substrate 20 is coated with an insulating material 14.

The display electrode array 21 deployed on the lower substrate 20, i.e., pixel electrodes, and the address electrode array 12 deployed on the upper substrate 10, i.e., common electrodes, defines a display matrix in a display area of the liquid crystal module for displaying graphic information under controlling of the controller 80.

Please referring from FIG. 5 to FIG. 7, the touch device comprises a plurality of touch pads 72, a plurality of electrodes 71, and a printed circuit board 76. Each of the touch pads 72 is combined with an indicating icon 78 showing specific operation which will be triggered by the touch pads 72. The plurality of touch pads 72 is arranged on the outer surface of the upper substrate 10. Each touch pad 72 is connected with an electrode 71. In the preferred embodiment of the present invention, the touch pads 72 adopts capacitive type of touch screen, and in the present embodiment, the touch pads 72 are ITO blocks, which are respectively etched on the outer surface of the upper substrate 10. The plurality of electrodes is aggregated through the interface 74. The interface 74 is connected with the printed circuit board 76. The controller 80 controlling graphic information display of the liquid crystal module is connected with the printed circuit board 76. The printed circuit board 76 distinguishes each touch pad 72 by recognizing current change created by a user, and pass the touch pad 72 identification information to the controller 80 for following process.

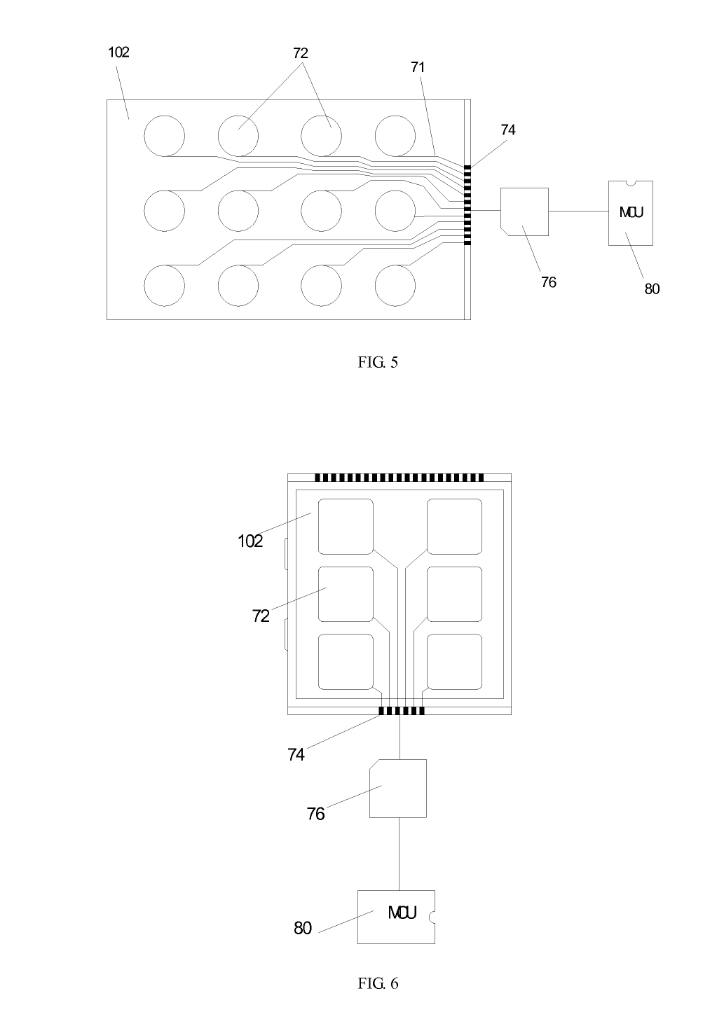

The touch pads 72 disclosed in the present embodiment can be designed in various shapes in accordance with different requirement and appliance, and the touch pads 72 can be distributed in different deployment on the outer surface of the upper substrate 10. With reference to FIG. 5, it shows one deployment embodiment of the touch pads 72. With reference to FIG. 6, it shows another deployment embodiment of the touch pads 72.

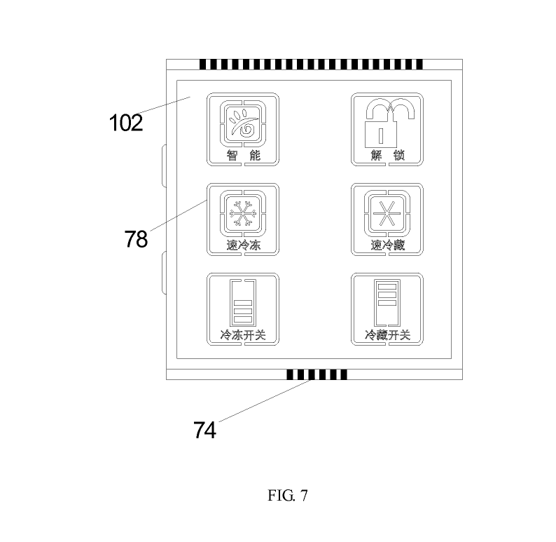

With reference to FIG. 7, Shape of the plural touch pads 72 is in consistency with that of the indicating icons 78, showing specific operation which will be triggered by the touch pads 72.

Each of the ITO blocks, i.e., the touch pads 72, is covered by a protecting layer (not shown). In the preferred embodiment of the present invention, the protecting layer is a polarizing plate.

According to the present invention, the liquid crystal module combines with the plurality of touch pads 72 of capacitive type right on the outer surface of the upper substrate 10, so that the display electrode array inside the liquid crystal module and the plurality of touch pads 72 are integrated on respective two surfaces of the upper substrate 10, thereby simplifying the configurations of the touch device, and minimizing thickness of the whole display assembly.

While the present invention has been illustrated by the description of the preferred embodiment thereof, and while the preferred embodiment has been described in considerable detail, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative examples shown and described.

We claim:

1. An liquid crystal display incorporating touch pad, comprising:
a liquid crystal module, comprising a lower substrate, an upper substrate and sealant, a gap defined between the lower substrate and the upper substrate, and filled with liquid crystal, the sealant sealing the gap;
a plurality of touch pads disposed on the outer surface of the upper substrate, each touch pad connecting with an electrode, each of the electrodes connected with a printed circuit board; and
a controller controlling graphic information display of the liquid crystal module, connected with the printed circuit board;
wherein the printed circuit board distinguishes each touch pad by recognizing current change created by a user, and pass the touch pad identification information to the controller for following process.

2. The liquid crystal display incorporating touch pad as described in claim 1, wherein the touch pads adopting capacitive type are ITO blocks, which are respectively etched on the outer surface of the upper substrate.

3. The liquid crystal display incorporating touch pad as described in claim 2, wherein the plurality of electrodes is aggregated through an interface.

4. The liquid crystal display incorporating touch pad as described in claim 3, wherein a display electrode array is formed on the lower substrate, and an address electrode array is formed on the upper substrate, thereby defining a display matrix in a display area of the liquid crystal module for displaying graphic information.

5. The liquid crystal display incorporating touch pad as described in claim 2, wherein each of the ITO blocks is covered by a protecting layer.

6. The liquid crystal display incorporating touch pad as described in claim 5, the protecting layer is a polarizing plate.
